(19) United States
(12) Patent Application Publication
(10) Pub. No.: US 2018/0084167 A1
(43) Pub. Date: Mar. 22, 2018

(54) STACKED-FILTER IMAGE-SENSOR SPECTROMETER AND ASSOCIATED STACKED-FILTER PIXELS

(71) Applicant: OmniVision Technologies, Inc., Santa Clara, CA (US)

(72) Inventors: Yin QIAN, Milpitas, CA (US); Chen-Wei LU, San Jose, CA (US); Jin LI, San Jose, CA (US); Dyson H. TAI, San Jose, CA (US)

(73) Assignee: OmniVision Technologies, Inc.

(21) Appl. No.: 15/269,834

(22) Filed: Sep. 19, 2016

(51) Int. Cl. H04N 5/225; H04N 9/04; H04N 5/378

(52) U.S. Cl. CPC H04N 5/2254; H04N 5/2253; H04N 5/378; H04N 9/04

(57) ABSTRACT

A stacked-filter image-sensor spectrometer includes an image sensor, a first color filter array, and a second color filter array. The image sensor has a pixel array including a plurality of pixels. The first color filter array has a plurality of first color filters, wherein each first color filter is located above at least one pixel. The second color filter array is located between the first color filter array and the image sensor and has a plurality of second color filters. Each second color filter is located above at least one pixel. Each of the plurality of pixels has thereabove a compound color filter formed of one of the second color filters and one of the first color filters, the second filter having a second passband that partially overlaps a first passband of the first color filter in a first overlapping wavelength range.

### BACKGROUND

Optical spectroscopy has been widely used to detect and quantify characteristics and concentrations of physical, chemical, or biological targets. A limitation to this technology is spectrometer size and cost. More specifically, spectrometers traditionally use a light dispersion method. A light dispersion system, which may include a prism or diffraction grating, disperses incoming light from a target sample into an optical spectrum, i.e., into components of different wavelengths. This optical spectrum is then scanned by an optical detector to investigate the spectral characteristics. Spectrometer size needs to exceed a volume required to accommodate both this light dispersion and the light dispersion system itself, which also contributes to spectrometer cost.

Spectrometers that use non-dispersion methods have been developed. For example, one type of spectrometer uses a metallic-dielectric layered structure (with nanoscale metallic embossing structures on a metal film) to filter incoming light. Based on the working principles of surface plasmon polariton (SPP), this metallic-dielectric filter selects a narrow wavelength band of light to pass through it, while blocking the rest of the light spectrum with surface plasmon. Since such a system does not require a bulky light-dispersion system, the spectrometer size is significantly reduced. However, fabricating SPP-based metallic-dielectric filters requires a complex wafer manufacturing process so spectrometer cost remains high.

### SUMMARY OF THE INVENTION

In one embodiment, a stacked-filter pixel is disclosed. A stacked-filter pixel has a substrate and a color filter stack. The substrate includes a photodetector element electronically coupled to pixel circuitry. The color filter stack has a first color filter, a second color filter, and a first inter-filter layer therebetween. The second color filter is located between the photodetector element and the first color filter and has a second passband that partially overlaps a first passband of the first color filter in a first overlapping wavelength range. The first inter-filter layer is at least partially transparent to the second passband.

In one embodiment, a stacked-filter image-sensor spectrometer is disclosed. The stacked-filter image-sensor spectrometer includes an image sensor, a first color filter array, and a second color filter array. The image sensor has a pixel array including a plurality of pixels. The first color filter array has a plurality of first color filters, wherein each first color filter is located above at least one pixel. The second color filter array is located between the first color filter array and the image sensor and has a plurality of second color filters. Each second color filter is located above at least one pixel. Each of the plurality of pixels has thereabove a compound color filter formed of one of the second color filters and one of the first color filters; the second filter has a second passband that partially overlaps a first passband of the first color filter in a first overlapping wavelength range.

### BRIEF DESCRIPTION OF THE FIGURES

FIGS. 1A-1B are cross-sectional views of a frontside illuminated pixel and a backside-illuminated pixel, respectively, each having a single layer color filter.

FIGS. 2A-2B are cross-sectional views of a frontside illuminated stacked-filter pixel and a backside illuminated stacked-filter pixel, respectively, in an embodiment.

FIGS. 3A-3B are diagrams of exemplary transmission spectra of color filters of the pixels of FIGS. 2A-2B.

FIG. 4 is a block diagram of a stacked-filter image-sensor spectrometer that includes stacked-filter pixels of either FIGS. 2A and 2B, in an embodiment.

FIG. 5 is a cross-sectional view of microlenses and color filters of a first exemplary pixel array of the stacked-filter image-sensor spectrometer of FIG. 4, in an embodiment.

FIG. 6 is an exemplary schematic transmission spectrum of a stacked filter of the stacked-filter image-sensor spectrometer of FIG. 4, in an embodiment.

FIG. 7 is a cross-sectional view of microlenses and color filters of a second exemplary pixel array of the stacked-filter image-sensor spectrometer of FIG. 4, in an embodiment.

### DETAILED DESCRIPTION OF THE EMBODIMENTS

In the present disclosure, a stacked filter image-sensor spectrometer uses a multi-layer stacked color filter to select a relatively narrow wavelength band for detection. The color filter works by light absorption, and is fabricated with standard photolithography processes. Cost of the final spectrometer product is accordingly low as compared to the prior art.

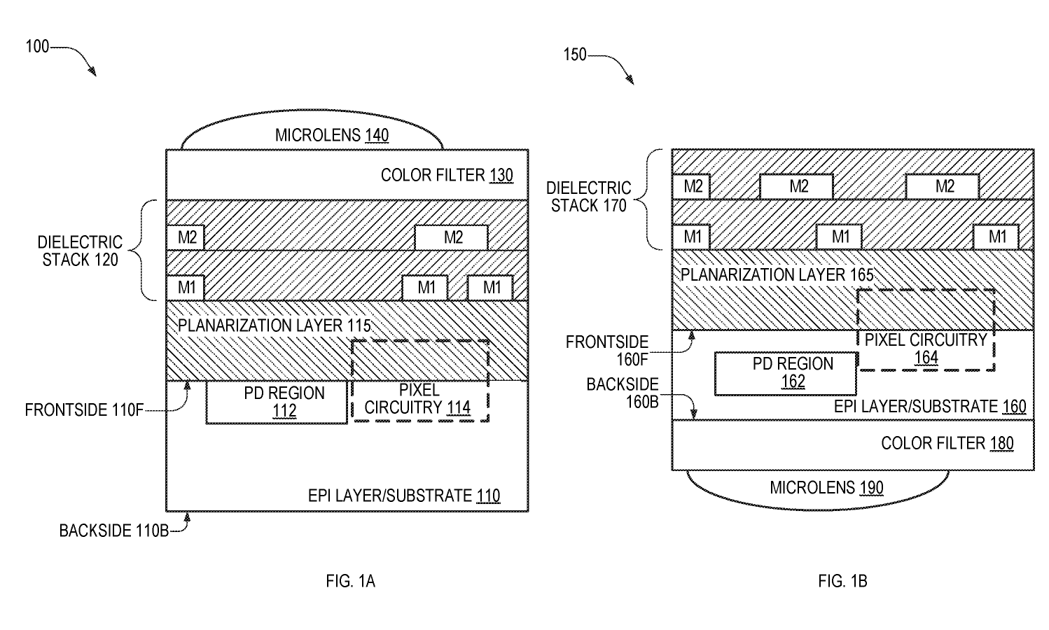

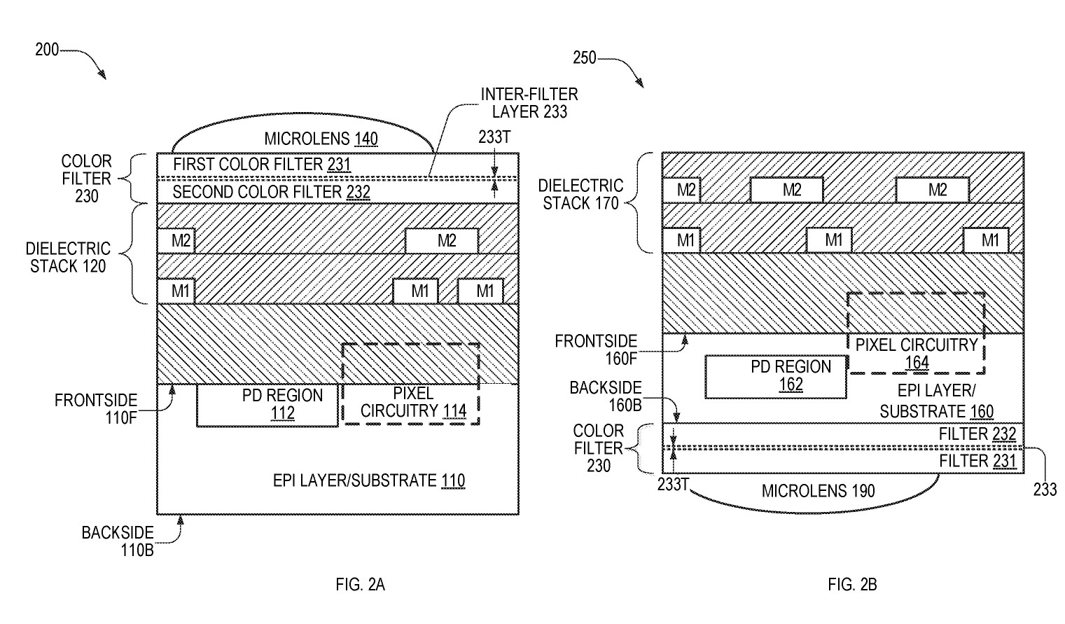

FIG. 1A illustrates a cross-section of an embodiment of a frontside-illuminated (FSI) pixel 100 in a solid state optical detection device based on CMOS image sensor pixel architecture. FSI pixel 100 includes a substrate 110 upon which a photodiode region 112 and associated pixel circuitry 114 are formed, and over which a dielectric stack 120 is formed. Dielectric stack 120 includes metal layers M1 and M2 for redistributing electrical signals. Metal layers M1 and M2 are patterned to allow optical passage of light incident on FSI pixel 100 to photodiode regions 112. A planarization layer 115 is between substrate 110 and dielectric stack 120. Pixel circuitry 114 may extend into planarization layer 115, as indicated by the dashed box around pixel circuitry 114.

Substrate 110 includes a frontside 110F and a backside 110B. To implement electromagnetic radiation (e.g., one or more of visible and near-infrared) detection, pixel 100 includes a color filter 130 disposed under a microlens 140, which focuses incident light onto photodiode regions 112. Color filter 130 may transmit any color with a wavelength within the visible wavelength range.

FIG. 1B illustrates a cross-section of a backside-illuminated (BSI) pixel 150 in a solid state optical detection device based on a CMOS image sensor pixel architecture. BSI pixel 150 includes a substrate 160 having a backside 160B and a frontside 160F. Substrate 160 includes a photodiode region 162 and associated pixel circuitry 164. Pixel 150 includes a dielectric stack 170, proximate frontside 160F, which includes metal layers M1 and M2 for redistributing electrical signals. Pixel 150 also includes a microlens 190 and a color filter 180 between microlens 190 and backside 160B. Color filter 180 may transmit one or both of visible and near-IR light. Microlens 190 aids in focusing incident light onto photodiode region 162. Backside illumination of pixels 150 means that metal interconnect lines M1 and M2 in dielectric stack 170 do not obscure the path between the object being imaged and the photodiode region 162, resulting in greater signal generation by photodiode region 162. A planarization layer 165 is between substrate 160 and dielectric stack 170. Pixel circuitry 164 may extend into planarization layer 165, as indicated by the dashed box around pixel circuitry 164.

FIG. 2A illustrates a cross-section of a FSI stacked-filter pixel 200 compatible for use in an image-sensor spectrometer based on CMOS image sensor pixel architecture. Stacked-filter FSI pixel 200 includes substrate 110, photodiode regions 112, pixel circuitry 114, dielectric stack 120, a compound color filter 230, and microlens 140 described above. A primary difference between pixels 100 and 200 is that compound color filter 230 of pixel 200 is a multi-layer structure, while pixel 100's color filter 130 is a single layer structure. Compound color filter 230 includes a first color filter 231 and a second color filter 232. Compound color filter 230 may include more than two color filters without departing from the scope hereof

Compound color filter 230 may include an inter-filter layer 233 situated directly between first color filter 231 and second color filter 232. Inter-filter layer 233 for example strengthens the structural integrity of the first and second color filters 231 and 232. It may also serve as a barrier to prevent or reduce diffusion of dyes and color pigments between color filters 231, 232. Inter-filter layer 233 may be at least partially transparent to the passband of second color filter 232. If inter-filter layer 233 lacks such transparency, second color filter 232 may not transmit any light incident on microlens 140. Herein, a color filter's passband refers to a range of wavelengths that the filter transmits above a specified value, such as a full-width half-maximum transmission value.

Inter-filter layer 233 may be made of various materials with optically transparent properties, including photoresist, resins, polymers, dielectrics, thin sheet of metals, etc. Inter-filter layer 233 may be formed of a dielectric material that is optically transparent, physically and chemically stable, and is able to stop diffusion of dyes and color pigments. Inter-filter layer 233 is, for example, made of a material that has a refractive index n₂₃₃ that is similar to the refractive index of the two color filters above and below it, in order to take advantage of index matching to reduce interface optical loss. Generally speaking, color filter materials are photoresist/resin with a refractive index of around 1.7, whereas the refractive index of commonly used dielectric in semiconductor devices is either too high or too low. For example, the refractive index of silicon oxide is too low (n≈1.46), while the refractive index of silicon nitride is too high (n≈2.0). Care should be taken to select the proper material for the inter-filter layer, so that its refractive index is close to the color filters, e.g., an arithmetic mean or geometric mean of the refractive indices of the top and the bottom color filters.

Inter-filter layer 233 has a thickness 233T. In an embodiment, inter-filter layer 233 a single-layer or multi-layer designed to be an anti-reflective coating between color filters 231 and 232 at a wavelength λ_{c}, transmitted by both filters 231 and 232. For example, inter-filter layer 233 is a single-layer thin film with refractive index n₂₃₃ equal to a geometric average of the refractive indices of filters 231 and 232, where thickness 233T equals 0.25 λ_{c}/n₂₃₃.

A candidate of this inter-filter material may include a glass substance, e.g., silicon oxide, which is doped with metal oxide dopants, e.g., titanium oxide, or zirconium oxide, such that the resulting refractive index is around 1.7. Another candidate may include silicon oxynitride, with its refractive index tuned to be around 1.7. Yet another candidate may be a transparent polymer, such as polycarbonate, with a refractive index of around 1.7.

FIG. 2B illustrates a cross-section of a BSI stacked-filter pixel 250 compatible for use in a stacked-filter image-sensor spectrometer based on CMOS image sensor pixel architecture. BSI stacked-filter pixel 250 includes substrate 160, photodiode region 162, pixel circuitry 164, dielectric stack 170, compound color filter 230, and microlens 190 described above. A primary difference between pixels 150 and 250 is that compound color filter 230 of pixel 250 is a multi-layer structure, while color filter 180 of pixel 150 is a single layer structure.

First color filter 231 may be characterized by a first passband. For example, the first color filter 231 includes chemical dye and/or pigment that absorbs certain wavelengths of light, thereby permitting transmission of light within a certain range of wavelengths complementary to the absorbed wavelengths. This type of color filter is based on absorption and is different from other filtering such as destructive interference (dichroic filter) and surface plasmon polariton. Second color filter 232 works similarly as the first color filter 231, and may be characterized by a second passband. The first and second passbands may be different, but they share a common overlapping wavelength range. For example, the first passband may be 500-550 nm, whereas the second passband may be 525-575 nm; thus the common overlapping wavelength range is 525-550 nm (i.e., the lower bound of the second passband and the upper bound of the first passband).

Compound color filter 230 may be characterized by a net passband. At least one of the first passband, the second passband, and the net passband may correspond to near-IR or IR wavelengths, e.g., wavelengths exceeding 0.75 micrometers. At least one of the first passband, the second passband, and the net passband may span visible and near-IR wavelengths. The net passband may have a center wavelength equal to wavelength λ_{c}, introduced above as a design wavelength for when inter-filter layer 233 is a single-layer antireflective coating.

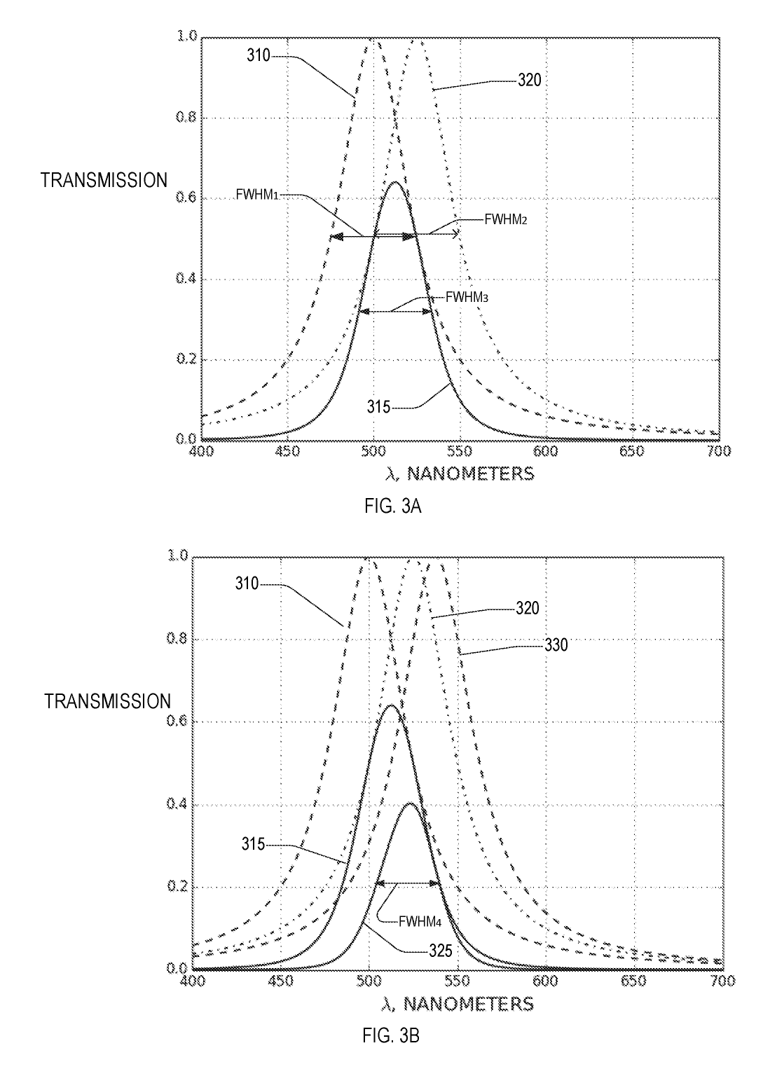

FIG. 3A is a plot of transmission spectra 310, 315, and 320. Transmission spectra 310 and 320 are each examples of a transmission spectrum of either first color filter 231 and second color filter 232. Net transmission spectrum 315 is the result of the overlapping of transmission spectra 310 and 320, and hence is an example of a transmission spectrum of compound color filter 230.

Transmission spectra 310 and 320 are Lorentzian functions with respective center wavelengths λ₁ and λ₂ and full-width half-maxima (FWHM) FWHM₁ and FWHM₂. In this example, FWHM₁=FWHM₂=50 nm, λ₁=500 nm, and λ₂=λ₁+α·FWHM₁=525 nm, where α=1/2. Transmission spectra 310 and 320 have overlapping passbands, which may be defined by the center wavelength and a linewidth such as a FWHM width, a e⁻¹ linewidth, or other conventions known in the art. Transmission spectra 310 and 320 have FWHM passbands of 500±25 nm and 525±25 nm respectively, which overlap as illustrated in FIG. 3A. Net transmission spectrum 315 is centered at λ₃=1/2 (λ₁+λ₂) and has a FWHM width FWHM₃, which in this example equals 42.1 nm.

As spectra describable by a standard continuous probability distribution, transmission spectra 310 and 320 may represent idealizations of actual transmission spectra of color filters 231 and 232, which may be asymmetric.

Net transmission does not always have a sharper appearance than the two transmission spectra. However, in the present example, net transmission spectrum 315 does have a sharper appearance than both transmission spectra 310 and 320 under the condition that λ₂=λ₁+α·FWHM₁ where α is less than approximately 0.67 and FWHM₁=FWHM₂. By overlapping the first and second color filters 231 and 232, and also purposefully controlling spectral parameters such as λ₁, λ₂, α, FWHM₁, FWHM₂, etc, a narrower wavelength range optical transmission may be achieved, albeit the maximum transmission level is generally reduced compared to transmission spectra 310 and 320. Narrower wavelength range optical transmission is a desired feature in spectroscopic analysis because it allows for more accurate wavelength related analysis.

The practice of overlapping two color filters that share a common overlapping wavelength range to achieve a relatively narrower wavelength range of optical transmission may be further extended to overlapping three or more color filters. See, e.g,. FIG. 3B. For example, as an alternative embodiment of both pixels 200 and 250 in FIGS. 2A-2B, the second color filter 232 may overlay an additional, third color filter (not shown in FIGS. 2A-2B), with another, optional inter-filter layer in between (also not shown). The third color filter may be characterized by a third passband that at least partially overlaps with the common overlapping range (of the first and second passbands) to achieve an even narrower passband.

For example, and as shown in FIG. 3B, a third transmission spectrum 330 characterizing the third color filter is partially overlapped with second transmission spectrum 320, and to a lesser extent, with the first transmission spectrum 310. More importantly, the third transmission spectrum 330 overlaps with net transmission spectrum 315, thereby producing a second net transmission spectrum 325. In the example of FIG. 3B, the third transmission spectrum 330 has a center wavelength λ₃=λ₂+α₃·FWHM₁=537.5 nm, where α₃=1/4 and a FWHM width FWHM₃=FWHM₁. Net transmission spectrum 325 is the result of overlapping of transmission spectra 310, 320 and 330 and has a FWHM width FWHM₄=17.5 nm. By overlaying a third color filter with a properly selected center wavelength and spectral width, an even narrower wavelength range optical transmission may be achieved, albeit the maximum transmission level is further reduced compared to net transmission spectrum 315. More color filters may be similarly added to achieve even narrower passbands.

In an embodiment, color filters 231 and 232 have Gaussian (or approximately Gaussian) transmission spectra having respective center wavelengths λ₁ and λ₂ and respective passband spectral widths σ₁ and σ₂, which denote a standard deviation of their respective Gaussian transmission spectrum. Compound color filter 230 has a center wavelength

$${λ}_{3} = \frac{{λ}_{1} {σ}_{2}^{2} + {λ}_{2} {σ}_{1}^{2}}{{σ}_{1}^{2} + {σ}_{2}^{2}}$$

and a spectral width σ₃=σ₁σ₂/\sqrt{σ₁²+σ₂²} that is less than both σ₁ and σ₂. For example, when σ₁=σ₂, σ₃=σ₁/\sqrt{2}. More generally, when

$${σ}_{2} = {βσ}_{1} , {σ}_{3}^{2} = \frac{{σ}_{1}^{2}}{( 1 + {β}^{- 2} )} = \frac{{σ}_{2}^{2}}{( 1 + {β}^{2} )} ,$$

which illustrates that σ₃ is less than both σ₁ and σ₂.

For any given wavelength, its passband spectral widths centering on that wavelength may vary, depending on the color filter's material composition and thickness. Purposeful selection of relatively narrow passband spectral widths σ₁ and σ₂ will help to narrow the resulting compound color filter's passband spectral width σ₃. For example, an appropriate blue (centered around 470 nm) filter material composition and thickness may be selected so that its spectral width σ≈70 nm; similarly a green filter (centered around 540 nm) may be selected have its spectral width σ≈80 nm, and a red filter (centered around 660 nm) may be selected to have spectral width σ≈67 nm. Generally speaking, the filter of a specific color may be purposefully selected so that its spectral width a is around a relatively narrow range of 70-80 nm. Then, the resulting compound filter (e.g., a two-layer filter) may have its spectral width σ around 50-55 nm, which is around 60%-80% of any single color filter that is a component of the compound filter.

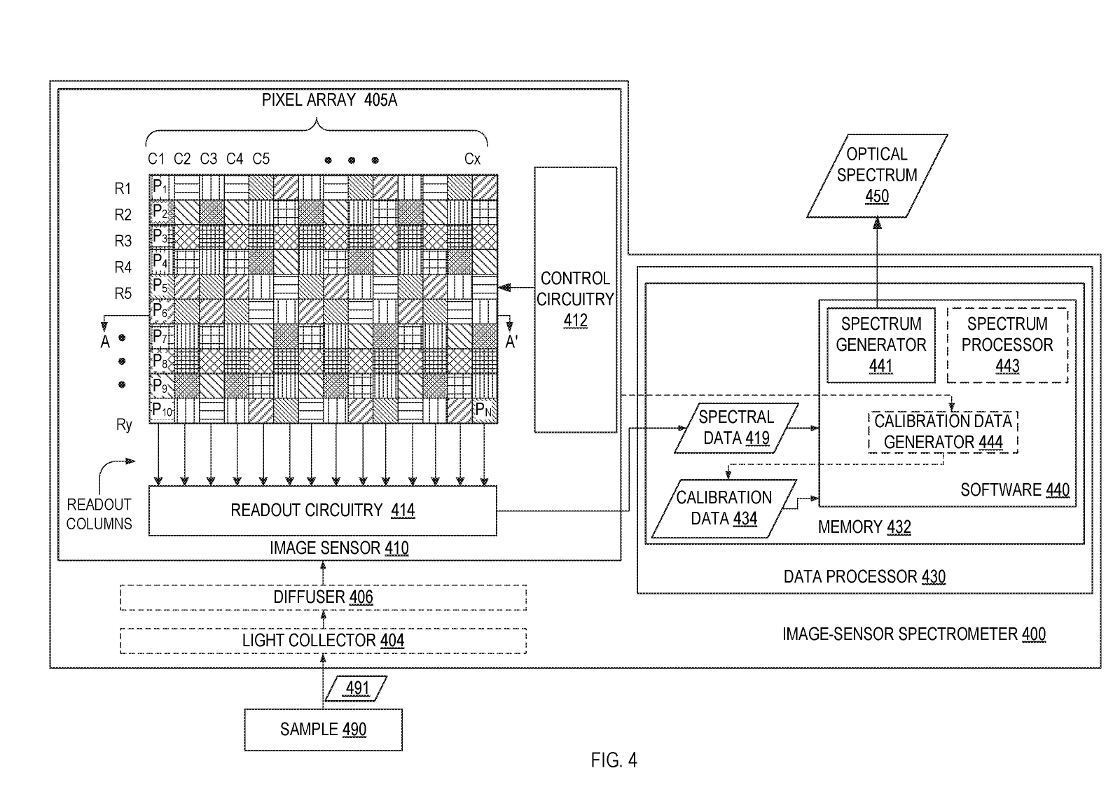

FIG. 4 illustrates a stacked-filter image-sensor spectrometer 400 that includes an image sensor 410 and a data processor 430. Image sensor 410 includes a pixel array 405A communicatively coupled to control circuitry 412 and readout circuitry 414. Data processor 430 includes a memory 432 that stores software 440, which includes a spectrum generator 441 and optionally a spectrum processor 443.

Stacked-filter image-sensor spectrometer 400 may also include at least one of a light collector 404 and a diffuser 406 in front of image sensor 410. Light collector 404 is for example a lens or an axicon.

Memory 432 may also store image sensor calibration data 434, which is based on properties of pixel array 405A such as each pixel's gain and transmission function of its color filter, e.g., compound color filter 230 or 280. Sensor calibration data 434 may be based on other properties of image sensor 410 without departing from the scope hereof. In an embodiment, data processor 430 receives calibration data 434 directly from image sensor 410. Alternatively, data processor 430 may include a calibration data generator 444 that generates calibration data 434 by processing data received from image sensor 410.

Readout circuitry 414 may include one or more of amplification circuitry, analog-to-digital (“ADC”) conversion circuitry, and other circuits. Control circuitry 412 is coupled to pixel array 405A to control operational characteristics of pixel array 405A. For example, control circuitry 412 may generate a shutter signal for controlling data acquisition.

Pixel array 405A is a two-dimensional array of individual pixels Pᵢ (e.g., pixels P₁, P₂ . . . , Pₙ)having X pixel columns and Y pixel rows. Each pixel Pᵢ, is for example either stacked-filter FSI pixel 200 or stacked-filter BSI pixel 250. As pixel array 405A includes stacked-filter pixels and is part of image sensor 410, image sensor 410 is an example of a stacked-filter image sensor. As illustrated in FIG. 4, each pixel in the array is arranged into a row (e.g., rows R1 to Ry) and a column (e.g., column C1 to Cx) to acquire spectral data (e.g., light transmission percentage at a certain wavelength λ±Δλ, where Δλ<<λ.) of a target sample 490, which can then be used to construct a spectral profile of the target sample 490.

In operation of stacked-filter image-sensor spectrometer 400, light 491 emitted or reflected from target sample 490 is incident on pixel array 405A. A plurality of pixels of pixel array 405A generates a photocurrent to readout circuitry 414. Readout circuitry 414 generates and outputs spectral data 419 to memory 432 of data processor 430.

In an embodiment, light collector 404 is positioned to image sample 490 onto pixel array 405A. In a different embodiment, light collector 404 is positioned to maximize the amount of light emitted or reflected from sample 490, regardless of whether sample 490 is imaged onto pixel array 405A. In such a configuration, optimized light collection may result in sample 490, light collector 404, and image sensor 410 being longitudinally positioned in a non-imaging configuration. Such a non-imaging configuration may be beneficial for reducing the volume of spectrometer 400. For example, a longitudinal distance between light collector 404 and image sensor 410 is less than a focal length of light collector 404, such that light collector 404 cannot form an image on image sensor 410.

Spectrum generator 441 is capable of constructing an optical spectrum 450 from spectral data 419 and, optionally, calibration data 434. Spectrum processor 443, if included, is capable of further processing and analyzing spectral data 419, for example, to ascertain physical, chemical, or other attributes of sample 490.

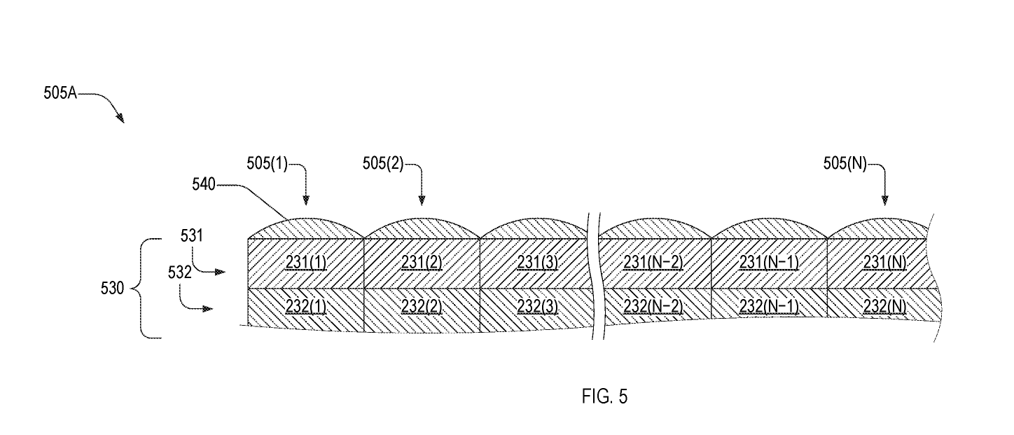

FIG. 5 is a cross-sectional view of microlenses and color filters of a pixel array 505A. Pixel array 505A is an example of pixel array 405A and the cross-sectional view of FIG. 5 is along cross-section A-A′ shown in FIG. 4. Pixel array 505A includes a plurality of pixels 505(1-N). Each pixel 505(i) has a microlens 540, a color filter 231(i), and a color filter 232(i). Microlens 540 is for example either microlens 140 or 190, FIG. 1. Color filters 231 and 232 are in color filter arrays (CFAs) 531 and 532 respectively. CFAs 531 and 532 form a stacked color filter array 530. Stacked color filter array 530 may have more than two layers color filter arrays without departing from the scope hereof.

Each filter pair 231(i) and 232(i) combines to yield a net transmission spectrum, such as net transmission spectrum 315, characteristic of a pixel 505(i), and hence what is referred to herein as a detector group of stacked-filter image-sensor spectrometer 400 characterized by a net transmission spectrum. The number of candidate color filter types available to each filter pair 231(i) and 232(i) determines the number of possible detector groups of spectrometer 400. Specifically, the maximum number of detector groups N_{g} equals the combination of k color filter layers and n color filter types:

$${N}_{g} = \frac{n !}{k ! ( n - k ) !} .$$

For k=2 CFA layers as shown in FIG. 5 and n=6 color filter types, N_{g}=15. For k=3 CFA layers and n=6 color filter types, N_{g}=20. Additionally, a color filter pair 231(i) and 232(i) may have the same transmission spectrum, such that

$${N}_{g} = \frac{n !}{k ! ( n - k ) !} + n .$$

For any same color filter pair situation, the resulting compound filter's passband spectral width will be relatively wider than a pair of different color filters.

In FIG. 4, each pixel Pᵢ of pixel array 405A is capable of receiving light corresponding to one of ten different net transmission spectra (and net passbands), represented by pixels P₁-P₁₀ that are each illustrated with a different fill pattern. The ten different net transmission spectra, each corresponding to a different detector group, may correspond to k=2 CFA layers and n=5 color filter types:

$${N}_{g} = \frac{5 !}{2 ! 3 !} = 10.$$

Image-sensor spectrometer 400 is shown with ten detector groups (represented by respective patterns of P₁-P₁₀) for illustrative purposes, and may have more or fewer detector groups without departing from the scope hereof. Hereinafter, P_{1-N}_{_{g}} refers to detector groups of image-sensor spectrometer 400, and Pᵢ refers to any one of detector groups P_{1-N}_{_{g}}.

Detector groups P_{1-N}_{_{g}} of image-sensor spectrometer 400, specifically the respective transmission spectral of their compound color filters, may span a single continuous spectral range or multiple non-overlapping spectral ranges. Examples of a single continuous range include part or all of the visible portion of the electromagnetic spectrum. An example of a multiple non-overlapping ranges is a plurality of single continuous spectral ranges corresponding to a spectral signature of a substance possibly present in sample 490. For example, a spectral signature may have distinguishing features only in the red and blue regions of the visible electromagnetic spectrum, such that each detector group Pᵢ detects either red or blue wavelengths and image-sensor spectrometer 400 does not detect green light.

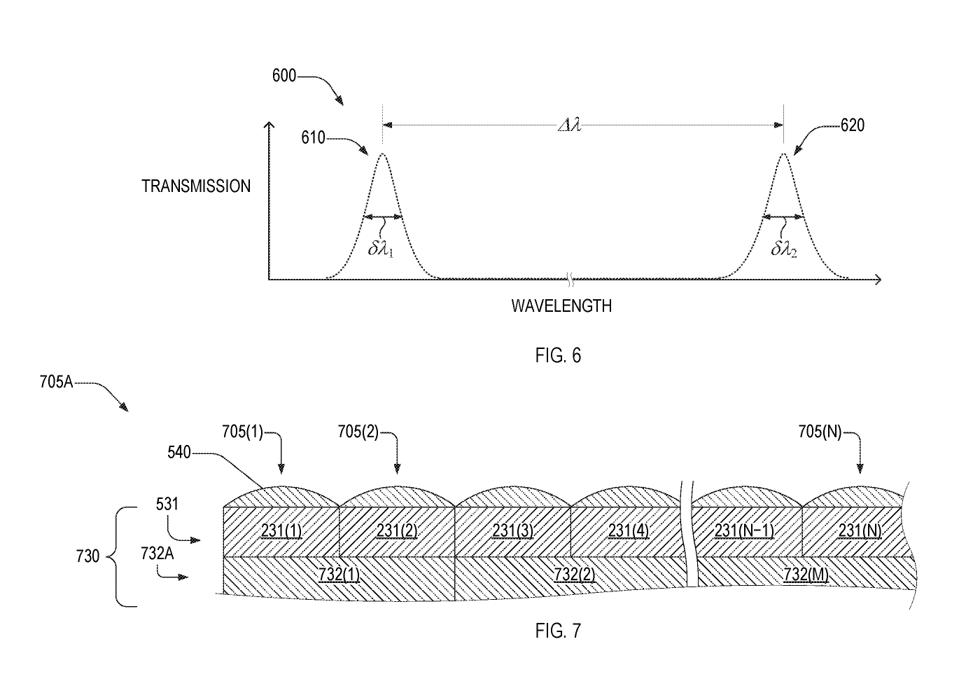

Detector groups P_{1-N}_{_{g}} may have respective transmission spectra, or more specifically passbands, optimized for resolving part or all of a specific spectral signature. In an embodiment, detector groups P_{1-N}_{_{g}} correspond to respective net passbands that do not all have the same spectral width. For example, the spectral width of a net passband of a detector group Pᵢ decreases according to the proximity of its center wavelength to a wavelength of a spectral signature, such as a resonance wavelength. A spectral signature may include two resonances with linewidths of approximately δλ that are separated in wavelength by Δλ>>δλ. For example, FIG. 6 is a schematic transmission spectrum 600 that includes passbands 610 and 620 with respective linewidths δλ₁ and δλ₂. Passbands 610 and 620 are separated by Δλ, where Δλ>>δλ₁ and Δλ>>δλ₂. Resonance separation Δλ is, for example, greater than an integer multiple of δλ: Δλ>α·δλ, where δλ=1/2(δλ₁+δλ₂). Integer α is, for example at least five. In an embodiment, first detector group Pₘ has a net passband that is wider than a net passband of second detector group Pₙ by a factor of

$$\frac{Δλ}{δλ} .$$

FIG. 7 is a cross-sectional view of microlenses and color filters of a pixel array 705A. Pixel array 705A is an example of pixel array 405A and the cross-sectional view of FIG. 7 is along cross-section A-A′ shown in FIG. 4. Pixel array 705A is similar to pixel array 505A, except that a CFA 732A replaces CFA 532. CFAs 531 and 732A form a stacked CFA 730. In pixel array 705A, CFA 531 is between CFA 732A and microlenses 540. Without departing from the scope hereof, stacked CFA 730 may be flipped such that CFA 732A is between CFA 531 and microlenses 540.

CFA 732A includes a plurality of color filters 732 that span more than one pixel 705. Optical properties of color filters 732, e.g., candidate passbands and transmission spectra, are similar to those of color filters 231. CFA 732A may also include a color filter that is beneath one and only one pixel 705. CFA 531 may include a color filter spanning more than one pixel 705.

One color filter 732(i) may span any number of contiguous pixels 705 forming different shapes. For example, a plurality of contiguous pixels 705 form an m x n array of pixels are m and n are positive integers. Alternatively, a plurality of contiguous pixels 705 may form a non-rectangular shape, for example one formed by intersecting rectangles such as an L-shape or a cross. In an embodiment, the plurality of contiguous pixels 705 is less than twenty-five percent of the total number of pixels in pixel array 705A.

In an embodiment, no color filter 732(i) of CFA 732A spans every pixel 705 of pixel array 705A, as CFA 732A includes other color filters 732(j≠i), that each cover at least one pixel 705 of pixel array 705A. When pixel array 705A is planar, CFA 732A may also be planar, such that two color filters 732 therein are coplanar. Hence the two color filters, such as 732(1) and 732(2) of FIG. 7, cannot be located over a same pixel 705.

The above description of illustrated embodiments of the invention, including what is described in the abstract, is not intended to be exhaustive or to limit the invention to the disclosed forms. While specific embodiments of, and examples for, the invention are described herein for illustrative purposes, various equivalent modifications are possible within the scope of the invention, as those skilled in the relevant art will recognize. These modifications can be made to the invention in light of the above detailed description.

Features described above as well as those claimed below may be combined in various ways without departing from the scope hereof. The following examples illustrate some possible, non-limiting combinations:

(A1) A stacked-filter pixel has substrate and a color filter stack. The substrate includes a photodetector element electronically coupled to pixel circuitry. The color filter stack has a first color filter, a second color filter, and a first inter-filter layer therebetween. The second color filter is located between the photodetector element and the first color filter and has a second passband that partially overlaps a first passband of the first color filter in a first overlapping wavelength range. The first inter-filter layer is at least partially transparent to the second passband.

(A2) In the stacked-filter pixel denoted by (A1), the color filter stack may have a net passband with a spectral width narrower than a spectral width of at least one of the first passband and the second passband.

(A3) In any stacked-filter pixel denoted by one of (A1) and (A2) in which the first passband has a first center wavelength and the second passband has a second center wavelength, a difference between the first center wavelength and the second center wavelength may be less than three-quarters of the width of the first passband.

(A4) Any stacked-filter pixel denoted by one (A1) through (A3) may further include, between the first color filter and the second color filter, a first inter-filter layer that is at least partially transparent to the second passband.

(A5) In any stacked-filter pixel denoted by one of (A1) through (A4), the color filter stack may further include a third color filter having a third passband at least partially overlapping the first overlapping wavelength range, the second color filter being between the first color filter and the third color filter.

(A6) The stacked-filter pixel denoted by (A5) may further include a second inter-filter layer between the second color filter and the third color filter, wherein the second inter-filter layer is at least partially transparent to the third passband.

(A7) In any stacked-filter pixel denoted by one of (A5) and (A6), in which the first, second, and third passbands have a first, second, and third center wavelength respectively, a difference between the first center wavelength and the second center wavelength may be less than three-quarters of the width of the first passband, and a difference between the second center wavelength and the third center wavelength may be less than one quarter of the width of the second passband.

(B1) A stacked-filter image-sensor spectrometer includes an image sensor, a first color filter array, and a second color filter array. The image sensor has a pixel array including a plurality of pixels. The first color filter array has a plurality of first color filters, wherein each of the first color filters is located above at least one pixel. The second color filter array is located between the first color filter array and the image sensor and has a plurality of second color filters. Each of the second color filters is located above at least one pixel. Each of the plurality of pixels has thereabove a compound color filter formed of one of the second color filters and one of the first color filters, the second filter having a second passband that partially overlaps a first passband of the first color filter in a first overlapping wavelength range.

(B2) In the stacked-filter image-sensor spectrometer denoted by (B1), each compound color filter may have a net passband that is one of a plurality of net passbands, a first sub-plurality of net passbands spanning a first spectral range, a second sub-plurality of net passbands spanning a second spectral range that does not overlap the first spectral range, the first and second sub-pluralities of net passbands constituting the plurality of net passbands.

(B3) In any stacked-filter image-sensor spectrometer denoted by one of (B1) and (B2), each compound color filter may have a net passband that is one of a plurality of net passbands that includes a first net passband having a first spectral width and a second net passband having a second spectral width that exceeds the first spectral width by at least a factor of five

(B4) In any stacked-filter image-sensor spectrometer denoted by one of (B1) through (B3), (a) one of the plurality of first color filters may be located above more than one pixel and (b) one of the plurality of second color filters may be located above more than one pixel.

(B5) In any stacked-filter image-sensor spectrometer denoted by one of (B1) through (B4), each compound color filter may have a net passband with a spectral width narrower than a spectral width of at least one of the first passband and the second passband

(B6) Any stacked-filter image-sensor spectrometer denoted by one of (B1) through (B4) may further include a light collector above the image sensor, the first and second color filter arrays located between the light collector and the image sensor, a distance between the light collector and the image sensor being less than a focal length of the light collector.

(B7) In any stacked-filter image-sensor spectrometer denoted by one of (B1) through (B6), each compound color filter may include a first inter-filter layer located between the first color filter and the second color filter and being at least partially transparent to the second passband

(B8) In any stacked-filter image-sensor spectrometer denoted by one of (B1) through (B7), the first passband having a first center wavelength, the second passband having a second center wavelength, a difference between the first center wavelength and the second center wavelength may be less than three-quarters of the width of the first passband

(B9) In any stacked-filter image-sensor spectrometer denoted by one of (B1) through (B8), the color filter may further include a third color filter, the second color filter being between the first color filter and the third color filter, and the third color filter having a third passband at least partially overlapping the first overlapping wavelength range.

(B10) The stacked-filter image-sensor spectrometer denoted by (B9) may further include a second inter-filter layer between the second color filter and the third color filter, wherein the second inter-filter layer is at least partially transparent to the third passband.

(B11) In any stacked-filter image-sensor spectrometer denoted by one of (B10) and (B11), in which the first, second, and third passbands have a first, second, and third center wavelength respectively, a difference between the first center wavelength and the second center wavelength may be less than three-quarters of the width of the first passband, and a difference between the second center wavelength and the third center wavelength may be less than one quarter of the width of the second passband.

(B12) In any stacked-filter image-sensor spectrometer denoted by one of (B1) through (B11), each first color filter may be located above at most a first number of contiguous pixels less than one-quarter of pixels in the pixel array, and each second color filter may be located above at most a second number of contiguous pixels less than one-quarter of pixels in the pixel array.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A stacked-filter pixel, comprising:
a substrate having a photodetector element electronically coupled to pixel circuitry; and
a color filter stack having a first color filter and a second color filter, the second color filter located between the photodetector element and the first color filter and having a second passband that partially overlaps a first passband of the first color filter in a first overlapping wavelength range.

2. The stacked-filter pixel of claim 1, the color filter stack having a net passband with a spectral width narrower than a spectral width of at least one of the first passband and the second passband.

3. The stacked-filter pixel of claim 1, the first passband having a first center wavelength, the second passband having a second center wavelength, a difference between the first center wavelength and the second center wavelength being less than three-quarters of the width of the first passband.

4. The stacked-filter pixel of claim 1, further comprising, between the first color filter and the second color filter, a first inter-filter layer that is at least partially transparent to the second passband.

5. The stacked-filter pixel of claim 1, the color filter stack further including a third color filter having a third passband at least partially overlapping the first overlapping wavelength range, the second color filter being between the first color filter and the third color filter.

6. The stacked-filter pixel of claim 5, further comprising a second inter-filter layer, located between the second color filter and the third color filter, that is at least partially transparent to the third passband.

7. The stacked-filter pixel of claim 5, the first, second, and third passbands having a first, second, and third center wavelength respectively, a difference between the first center wavelength and the second center wavelength being less than three-quarters of the width of the first passband, a difference between the second center wavelength and the third center wavelength being less than one quarter of the width of the second passband.

8. A stacked-filter image-sensor spectrometer, comprising:
an image sensor having a pixel array formed of a plurality of pixels;
a first color filter array having a plurality of first color filters, each of the first color filters located above at least one pixel; and
a second color filter array, located between the first color filter array and the image sensor, having a plurality of second color filters, each of the second color filters located above at least one pixel, and
wherein each of the plurality of pixels has thereabove a compound color filter formed of one of the second color filters and one of the first color filters, the second filter having a second passband that partially overlaps a first passband of the first color filter in a first overlapping wavelength range.

9. The stacked-filter image-sensor spectrometer of claim 8, each compound color filter having a net passband that is one of a plurality of net passbands, a first sub-plurality of net passbands spanning a first spectral range, a second sub-plurality of net passbands spanning a second spectral range that does not overlap the first spectral range, the first and second sub-pluralities of net passbands constituting the plurality of net passbands.

10. The stacked-filter image-sensor spectrometer of claim 8, each compound color filter having a net passband that is one of a plurality of net passbands that includes a first net passband having a first spectral width and a second net passband having a second spectral width that exceeds the first spectral width by at least a factor of five.

11. The stacked-filter image-sensor spectrometer of claim 8, wherein (a) one of the plurality of first color filters is located above more than one pixel and/or (b) one of the plurality of second color filters is located above more than one pixel.

12. The stacked-filter image-sensor spectrometer of claim 8, each compound color filter having a net passband with a spectral width narrower than a spectral width of at least one of the first passband and the second passband.

13. The stacked-filter image-sensor spectrometer of claim 8, further comprising a light collector above the image sensor, the first and second color filter arrays located between the light collector and the image sensor, a distance between the light collector and the image sensor being less than a focal length of the light collector.

14. The stacked-filter image-sensor spectrometer of claim 8, each compound color filter further comprising a first inter-filter layer located between the first color filter and the second color filter and being at least partially transparent to the second passband.

15. The stacked-filter image-sensor spectrometer of claim 8, the first passband having a first center wavelength, the second passband having a second center wavelength, a difference between the first center wavelength and the second center wavelength being less than three-quarters of the width of the first passband.

16. The stacked-filter image-sensor spectrometer device of claim 8, the color filter further including a third color filter, the second color filter being between the first color filter and the third color filter, and the third color filter having a third passband at least partially overlapping the first overlapping wavelength range.

17. The stacked-filter image-sensor spectrometer device of claim 16, further comprising a second inter-filter layer, located between the second color filter and the third color filter, that is at least partially transparent to the third passband.

18. The stacked-filter image-sensor spectrometer of claim 16, the first, second, and third passbands having a first, second, and third center wavelength respectively, a difference between the first center wavelength and the second center wavelength being less than three-quarters of the width of the first passband, a difference between the second center wavelength and the third center wavelength being less than one quarter of the width of the second passband.

19. The stacked-filter image-sensor spectrometer of claim 8,
each first color filter being located above at most a first number of contiguous pixels less than one-quarter of pixels in the pixel array;
each second color filter being located above at most a second number of contiguous pixels less than one-quarter of pixels in the pixel array.
